(19) United States
(12) Patent Application Publication
(10) Pub. No.: US 2012/0217252 A1
(43) Pub. Date: Aug. 30, 2012

(54) DOUBLE COOKWEAR AND METHOD FOR MANUFACTURING THE SAME

(75) Inventor: KWANG SOON JUNG, SEOUL (KR)

(73) Assignees: KWANG SOON JUNG, SEOUL (KR); CHA SIK KIM, SEOUL (KR)

(21) Appl. No.: 13/147,222

(22) Filed: Aug. 1, 2011

Related U.S. Application Data
(63) Continuation-in-part of application No. PCT/KR2009/004229, filed on Jul. 29, 2009.

(30) Foreign Application Priority Data
Feb. 27, 2009 (KR) 10-2009-0017302

(51) Int. Cl. A47J 27/00; B21J 15/02

(52) U.S. Cl. 220/573.4; 29/525.06

(57) ABSTRACT

The present invention discloses double cookware and a method for manufacturing the same. The disclosed double cookware includes an inner vessel and an outer vessel. A protrusion is formed on a side surface of the outer vessel and includes a rivet hole. A safe connection member is connected to a handle to be coupled to the rivet hole and has a joint hole formed therein. A rivet is inserted into the joint hole via the rivet hole and forcibly secured thereto. A to space is defined between a bottom of the inner vessel and a bottom of the outer vessel when inserting the inner vessel into the outer vessel. A bimetal through-hole is formed in a bimetal sensor in order to mount the bimetal sensor, which is automatically opened/closed depending on temperature, to the protrusion. A thread hole is formed in the protrusion to be fastened by a bimetal fastening bolt. A fastening bolt presses and secures the inner vessel through a threaded portion of the safe fastening unit and a connection hole of the outer vessel.

### CROSS-REFERENCE TO RELATED APPLICATIONS

This application is a continuation-in-part application claiming priority to PCT/KR2009/004229 filed Jul. 29, 2009, which claims priority to Korean Application No. 10-2009-001 7302 filed Feb. 27, 2009, entitled DOUBLE COOKWARE AND METHOD FOR MANUFACTURING THE SAME.

### BACKGROUND

1. Field of Technology

The present invention relates to double cookware and a method for manufacturing the same and, more particularly, to double cookware that has a heat-retaining space defined between an inner vessel and an outer vessel and includes a handle capable of preventing deterioration of a grip, and a method for manufacturing the same.

2. Description

In general, food to be cooked is put into cookware and heat is applied to the cook ware, so that the food is cooked by the heated cookware.

Further, the cookware may be single-wall cookware or may be double cookware including an inner vessel and an outer vessel.

In the case where the cookware is double cookware, food in the inner vessel is uniformly heated and cooked by a heat-retaining space defined between the inner vessel and the outer vessel.

A handle is mounted on an outer surface of the cookware so that the cookware can be carried to a desired place.

It should be noted that the above description is provided for understanding of the background art and is not a description of a well-known technique in the art.

Conventional double cookware suffers from high manufacturing costs and defect rate due to difficulty in coupling an inner vessel and an outer vessel.

Further, a handle attached to the cookware is in direct contact with the outer vessel, so that heat can be transferred to the handle during cooking, thereby causing deterioration and deformation of the handle. Further, when an additional member is provided to separate the handle from the cookware, production costs increase.

Further, a separate working process is performed in order to fasten the handle to the outer vessel with the inner vessel coupled to the inside of the outer vessel, thereby reducing productivity due to an increase in the number of working processes. Therefore, there is a need for overcoming these disadvantages.

### SUMMARY

The present invention is conceived to solve such problems in the art, and an aspect of the present invention is to provide a handle capable of preventing productivity deterioration, to which can occur due to a handle fastening process separate from a process of coupling an inner vessel and an outer vessel, and double cookware including the same.

Another aspect of the present invention is to provide a handle capable of preventing deterioration and defect thereof due to heat transferred to the handle during cooking, and double cookware including the same.

A further aspect of the present invention is to provide a handle capable of preventing an increase in manufacturing costs, which can occur due to use of large amounts of material for reinforcement of a member for separating the handle from cookware, and double cookware including the same.

Yet another aspect of the present invention is to provide a handle capable of preventing water from being introduced into a space between an outer vessel and an inner vessel through a through-hole formed in the outer vessel, and double cookware including the same.

In accordance with an aspect of the present invention, double cookware includes: an inner vessel and an outer vessel, a protrusion formed on a lateral side of the outer vessel, a rivet hole formed in the protrusion, a safe connection member connected to a handle to be coupled to the rivet hole and having a joint hole formed therein, a rivet inserted into the joint hole via the rivet hole and forcibly secured thereto, a space defined between a bottom of the inner vessel and a bottom of the outer vessel when inserting the inner vessel into the outer vessel, a bimetal through-hole formed in a bimetal sensor in order to mount the bimetal sensor, which is automatically opened/closed depending on temperature, to the protrusion, a thread hole formed in the protrusion to be fastened by a bimetal fastening bolt, and a fastening bolt compressing and securing the inner vessel with respect to the outer vessel through a threaded portion of the safe fastening unit and a connection hole of the outer vessel.

The safe connection member may include a horizontal support section, an inclined section inclined downward at either side of the support section, and securing sections bent from both sides of the inclined section to contact and be secured to the outer vessel. Here, the support section, the inclined section and the securing sections are formed by bending a metal piece positioned vertically.

The bottom of the outer vessel and the bottom of the inner vessel may define a heat-retaining space therebetween, a lateral channel may form an air passage between the outer vessel and the inner vessel to communicate with the heat-retaining space, and an embossed portion of the bimetal sensor mounted on a mounting portion communicating with the lateral channel may be inserted into an air exhaust hole formed in the mounting portion. The embossed portion of the bimetal sensor is automatically opened and closed in accordance with the temperature of the to heat-retaining space and the lateral channel

A packing member for preventing water from flowing into a through-hole for securing the inner vessel may be inserted into the connection hole of the outer vessel.

The outer vessel may be provided at opposite sides thereof with handles having short grips and safe connection members for mounting the handles, respectively.

The outer vessel may be provided at one side thereof with a handle having a short grip and a safe connection member for mounting the handle, and at the other side thereof with a handle having a long grip and a safe connection member for mounting the handle.

The handle may have a space which surrounds the safe connection member and the protrusion.

The handle may include a first handle extending in a lateral direction of the outer vessel and including a first grip member to be gripped by a user.

The first handle may include a first handle body installed to contact the outer vessel and having an inner space surrounding the safe connection member and the protrusion, and a first extension member extending in the lateral direction from the first handle body. The first grip member is fastened to the first extension member.

The first grip member and the first extension member may protrude in a direction of crossing each other, and may be fastened to each other by a first handle securing bolt with a lower side of the first extension member contacting an upper side of the first grip member.

The handle may include a second handle extending in a lateral direction of the outer vessel and including a second grip member to be gripped by a user.

The second handle may include a second handle body installed to contact the outer vessel and having an inner space surrounding the safe connection member and the protrusion, and a second extension member extending in the lateral direction from the second handle body, and a coupling groove may be provided inside the second grip member opposite the second extension member. Here, the second extension member is inserted into the coupling groove and being fastened thereto by a second handle securing bolt.

The safe connection member may include a securing piece having the joint hole communicating with a rivet holes formed at either side of the protrusion and installed to contact the protrusion; and a connecting piece bent from the securing piece towards the handle and having a screw hole formed therein.

In accordance with another aspect of the present invention, a method of manufacturing double cookware includes: preparing an outer vessel and an inner vessel and forming a protrusion on the outer vessel; inserting a packing member for preventing water inflow into a connection hole formed in the protrusion; compressing and securing a rivet having passed to through a rivet hole of the outer vessel and a joint hole of a safe connection member, with the safe connection member placed on an outer surface of the packing member; forming a heat-retaining space by inserting the inner vessel into the outer vessel; mounting a bimetal sensor on the protrusion of the outer vessel by forming a bimetal through-hole in the bimetal sensor and a thread hole in the protrusion and fastening the bimetal fastening bolt thereto; and securing the inner vessel with a fastening bolt compressing and securing the inner vessel through a threaded portion of the safe connection member and a connection hole of the outer vessel.

In accordance with a further aspect of the present invention, a method of manufacturing double cookware includes: preparing an outer vessel and an inner vessel and forming protrusions at opposite sides of the outer vessel; inserting a packing member for preventing water inflow into a connection hole provided in the protrusion; compressing and securing a rivet having passed through a rivet hole of the outer vessel and joint holes of safe connection members, with the safe connection members placed on an outer surface of the packing member; forming a heat-retaining space by inserting the inner vessel into the outer vessel; mounting a bimetal sensor on the protrusion of the outer vessel by forming a bimetal through-hole in the bimetal sensor and a thread hole in the protrusion and fastening the bimetal fastening bolt thereto; and securing the inner vessel with a fastening bolt compressing and securing the inner vessel through a threaded portion of the safe connection member and a connection hole of the outer vessel, and with another fastening bolt compressing and securing the inner vessel through a threaded portion of the safe connection member and the connection hole of the outer vessel.

As such, double cookware according to exemplary embodiments may have improved productivity since a process of fastening the handle and a process of coupling the inner vessel and the outer vessel are performed at the same time.

Further, since the handle is not in direct contact with the cookware, it is possible to prevent deterioration of the handle due to heat transferred to the handle during cooking.

Further, a safe connection member including inclined sections and securing sections for connecting the handle and the cookware is installed vertically to the cookware, thereby improving structural integrity of the cookware while reducing manufacturing costs.

Furthermore, a packing member surrounding a fastening bolt is disposed in a through-hole formed in the outer vessel, thereby preventing water from being introduced into a space between the outer vessel and the inner vessel through the through-hole.

### BRIEF DESCRIPTION OF THE DRAWINGS

The above and other aspects, features and advantages of the invention will become apparent from the following description of exemplary embodiments given in conjunction with the accompanying drawings, in which:

FIG. 1 is an exploded perspective view of double cookware with a handle according to a first exemplary embodiment of the present invention;

FIG. 2 is a perspective view of the double cookware including the handle shown in FIG. 1;

FIG. 3 is a side view of the double cookware including the handle shown in FIG. 2;

FIG. 4 is a side sectional view of a packing member disposed in a through-hole shown in FIG. 3;

FIG. 5 is an exploded perspective view of double cookware including a handle according to a second exemplary embodiment of the present invention;

FIG. 6 is an exploded perspective view of double cookware including a handle according to a third exemplary embodiment of the present invention;

FIG. 7 is an exploded perspective view of double cookware including a handle according to a fourth exemplary embodiment of the present invention;

FIG. 8 is a perspective view of the double cookware including the handle according to the fourth exemplary embodiment of the present invention;

FIG. 9 is a side view of the double cookware according to the fourth exemplary embodiment of the present invention;

FIG. 10 is a cross-section of the handle according to the fourth exemplary embodiment of the present invention;

FIG. 11 is an exploded perspective view of double cookware including a handle according to a fifth exemplary embodiment of the present invention;

FIG. 12 is a perspective view of the double cookware including the handle according to the fifth exemplary embodiment of the present invention;

FIG. 13 is a side view of the double cookware according to the fifth exemplary embodiment of the present invention; and

FIG. 14 is a cross-section of the handle according to the fifth exemplary embodiment of the present invention.

### DETAILED DESCRIPTION

Embodiments of the present invention will now be described in detail with reference to the accompanying drawings. It should be noted that the drawings are not to precise scale and may be exaggerated in thickness of lines or size of components for descriptive convenience and clarity only. Furthermore, terms used herein are defined by taking functions of the present invention into account and can be changed according to the custom or intention of users or operators. Therefore, definition of the terms should be made according to the overall disclosure set forth herein.

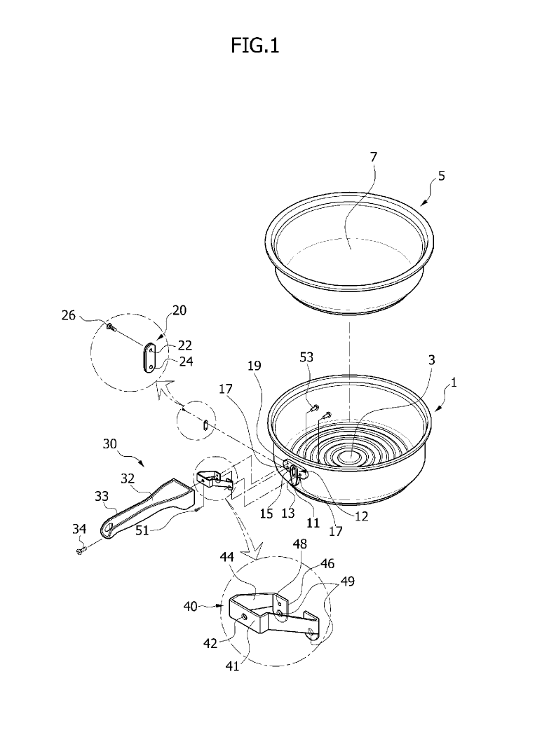

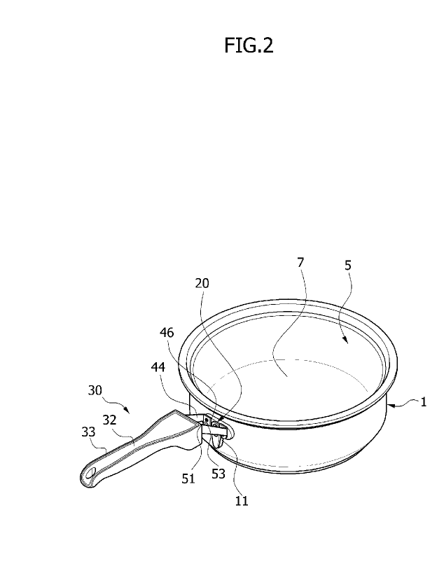

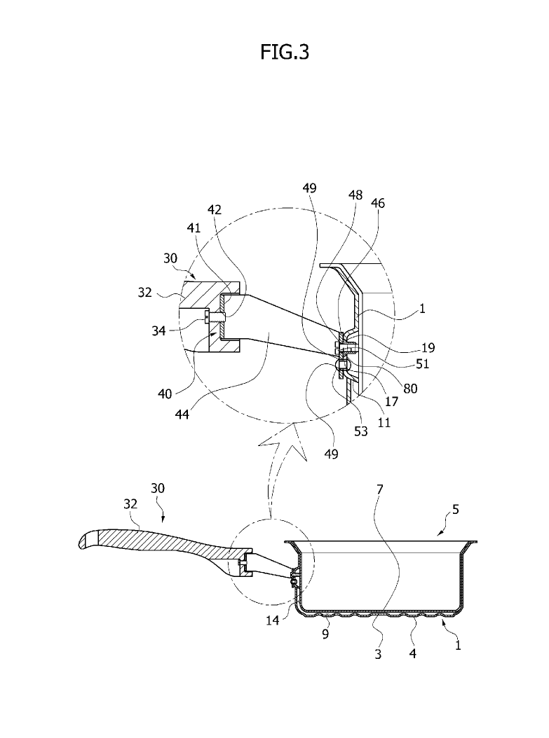

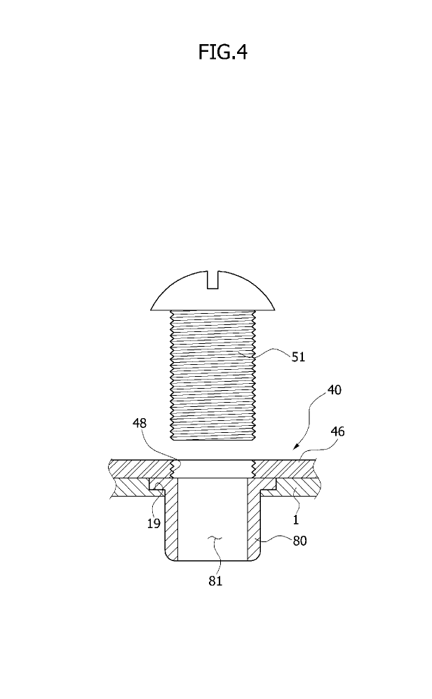

FIG. 1 is an exploded perspective view of double cookware with a handle according to a first exemplary embodiment, FIG. 2 is a perspective view of the double cookware including the handle shown in FIG. 1, FIG. 3 is a side view of the double cookware including the handle shown in FIG. 2, and FIG. 4 is a side sectional view of a packing member disposed in a through-hole shown in FIG. 3.

Referring to FIGS. 1 to 4, the cookware according to this embodiment is formed with a grip 32 made of a thermally insulating material.

A handle 30 provided with the grip 32 may have various shapes. According to one embodiment, the grip 32 includes a first glossy boundary line 33 at a rim thereof, and the other parts of the grip 32 except for the first boundary line 33 may be subjected to matt finish.

Further, a safe connection member 40 contacting and secured to one side of the grip 32 includes a horizontal support section 41, an inclined section 44 bent from either side of the support section 41 and inclined downward, and securing sections 46 bent from a lower side of the inclined section 44 to contact an outer vessel 1.

Further, an inner vessel 5 is inserted into the outer vessel 1 to form a double structure having a heat-retaining space 9 defined by a predetermined space between a bottom 3 of the outer vessel 3 and a bottom 7 of the inner vessel 5. One of the securing sections 46 is formed with a threaded portion 48 as a female-thread hole, and the outer vessel 1 is formed with a connection hole 19, so that a fastening bolt 51 is fastened to the threaded portion 48 and presses an outer surface of the inner vessel 5 through the connection hole 19, thereby securing the inner vessel 5 to the outer vessel 1.

The heat-retaining space 9 serves to retain heat transferred from the bottom of the outer vessel 1 for a predetermined period of time.

The outer vessel 1 is formed at the bottom 3 thereof with a plurality of circular grooves having different diameters to form an uneven bottom.

The uneven bottom and the heat-retaining space 9 minimize the outward emission of heat transferred to the outer vessel 1, thereby enhancing cooking speed.

Further, the heat passes through the heat-retaining space 9 instead of being directly transferred to food. Thus, food is prevented from being scorched and stuck to the bottom of the inner vessel 5 and burned, and is kept warm for long time after cooking is completed.

The threaded portion 48 is internally threaded and coupled to a male thread formed on an outer surface of the fastening bolt 51.

Each of the securing sections 46 is formed with a joint hole 49 through which a rivet 53 passes, and the outer vessel 1 is formed with a rivet hole 17 to communicate with the joint hole 49, so that the rivet 53 can pass through the rivet hole 17 of the outer vessel 1 and the joint hole 49 of the securing section 46 in sequence to be fastened thereto by forcible fixing. As a result, the handle 30 is secured to the outer surface of the outer vessel 1.

Further, a bolt may be used instead of the rivet 53 in order to fasten the securing section 46 to the outer vessel 1.

To use a bolt for coupling the securing section 46 provided at one side of the safe connection member 40 to the outer vessel 1, the securing section 46 is formed with a female thread for the bolt, and a bolt plate having a female thread is additionally interposed between the outer vessel 1 and the inner vessel 5. With this configuration, the bolt is primarily fastened to the securing section 46, inserted into the rivet hole 17, and secondarily fastened to the bolt plate between the outer vessel 1 and the inner vessel 5, thereby coupling the securing section 46 to the outer surface of the outer vessel 1.

The joint holes 49 are respectively formed in the left and right securing sections 46, and the threaded portion 48 is formed in one of the securing sections 46, without being limited thereto. It should be understood that the number and positions of the joint holes 49 and the threaded portion 48 may be varied.

The safe connection member 40 serves as an intermediate member for coupling the handle 30 and the outer vessel 1 in a state of being spaced apart from each other.

Further, the support section 41, the inclined section 44 and the securing sections 46 of the safe connection member 40 may be formed by bending a metal piece positioned in the vertical direction (see FIG. 1).

If the inclined section 44 is laid in the horizontal direction (see FIG. 1), the inclined section 44 is likely to be bent when the grip 32 is subjected to force in the vertical direction.

However, when the inclined section 44 is positioned in the vertical direction as shown in FIG. 1, a vertical size of the inclined section 44 is thicker than that of the inclined sections in the case where the inclined section 44 is positioned in the horizontal direction, thereby allowing the inclined section 44 to sustain force transferred thereto in the vertical direction. As a result, the inclined section 44 is not easily deformed even by force applied to the grip 32 in the vertical direction when a user grips the handle.

With this structure of reinforcing the inclined sections 44 by positioning the inclined section 44 in the vertical direction, it is possible to prevent the inclined section 44 from being bent while using a small amount of material for the inclined section 44.

The support section 41 and the inclined section 44 of the safe connection member 40 are formed to have a square-cornered ‘C’ shape, and an angle between the support section 41 and the inclined section 44 may be adjusted, as needed.

Further, the inclined section 44 may slope to be higher in a direction of the grip 32 and lower at portions where the inclined section 44 contacts the outer vessel 1. Alternatively, the inclined section 44 may slope opposite to this configuration, or may be installed parallel according to various embodiments.

The securing sections 46 provided at both sides of the inclined section 44 may be bent inwards from the inclined section 44, or may be bent outwards from the inclined section 44 as needed.

The safe connection member 40 is formed with a screw hole 42, and the grip 32 is formed with a hole through which a coupling bolt 34 is fastened to the screw hole 42 of the safe connection member 40, so that the safe connection member 40 can be secured to the grip 32.

Further, a lateral channel 14 forming an air passage is provided between the outer vessel 1 and the inner vessel 5 to communicate with the heat-retaining space 9.

The lateral channel 14 is connected to a protrusion 11 protruding in an outer direction of the outer vessel 1, and the protrusion 11 is provided with a mounting portion 12 on which a bimetal sensor 20 may be mounted.

The bimetal sensor 20 is automatically opened and closed in accordance with the temperature of the heat-retaining space 9 and the lateral channel 14, i.e. temperature of the portion on which the bimetal sensor 20 is mounted.

The bimetal sensor 20 is made of a bimetal material that operates at a preset temperature. Alternatively, such an opening/closing device may be achieved by a flat spring that operates at a preset pressure or more.

The mounting portion 12 is formed at a lower side thereof with an air exhaust hole 13, which communicates with the heat-retaining space 9, and at an upper side thereof with a thread hole 15, which has a female thread formed on an inner circumference of the hole to be fastened by a bimetal fastening bolt 26.

The bimetal sensor 20 is provided at a lower side thereof with an embossed portion 24 protruding to block the air exhaust hole 13, and at an upper side thereof with a bimetal through-hole 22 for the bimetal fastening bolt 26.

The different metals of the bimetal sensor 20 have different coefficients of thermal expansion. Thus, the bimetal sensor 20 is rotated about a lower fastening point in a direction of moving away from the outer vessel 1 at a preset temperature or higher, so that the embossed portion 24 can be separated from the air exhaust hole 13.

If the flat spring is used instead of the bimetal sensor 20, air inside the heat-retaining space 9 compresses the flat spring and is exhausted outward when the heat-retaining space 9 is heated to high temperature and high pressure.

That is, when air inside the heat-retaining space 9 and the lateral channel 14 is heated at a preset temperature or higher, the bimetal sensor 20 automatically exhausts the air to prevent accidents and enhance product durability.

Next, a method of manufacturing the double cookware according to the first embodiment of the invention will be described with reference to the accompanying drawings.

Referring to FIGS. 1 to 3, the cookware of this embodiment includes the outer vessel 1 and the inner vessel 5, and needs a process of forming the protrusion 11 on the outer vessel 1.

The protrusion 11 is formed by pressing or injection-molding the outer vessel 1 to protrude outward from a lateral side of the outer vessel 1.

Referring to FIG. 4, a packing member 80 is inserted into a connection hole 19 defined in the protrusion 11 to prevent water inflow.

The packing member 80 is made of a resilient material such as a rubber material and is formed to have a ‘T’-shape. The packing member 80 is internally formed with a through-hole 81 for a fastening bolt. The connection hole 19 for the packing member 80 is provided with a stepwise groove so that an upper side of the packing member 80 (refer to FIG. 4 hereinafter) can be caught and fixed thereto.

The through-hole 81 in the packing member 80 has a smaller diameter than that of a fastening bolt 51, so that the fastening bolt 51 can be forcibly fitted into the packing member 80.

The packing member 80 is used to prevent water inflow between the outer vessel 1 and the inner vessel 5 along the outer surface of the fastening bolt 51.

Further, with the safe connection member 40 put on the outer surface of the packing member 80, a rivet 53 is inserted into the rivet hole 17 of the outer vessel 1 and the joint hole 49 of the safe connection member 40 to be firmly fixed thereto.

To secure the safe connection member 40 to the outer vessel 1 for preventing deterioration of the handle 30, the protrusion 11 of the outer vessel 1 is formed with a rivet hole 17, and the safe connection member 40 is also formed with a joint hole 49. The rivet 53 is assembled from an inner surface of the outer vessel 1 towards the joint hole 49 of the safe connection member 40 via the rivet hole 17 of the outer vessel 1, such that one end of the rivet 53 is compressed and secured.

As the rivet 53 is compressed, the securing section 46 of the safe connection member 40 is installed to contact the outer surface of the packing member 80, thereby preventing separation of the packing member 80.

Then, the inner vessel 5 is inserted into the outer vessel 1 to form a heat-retaining space 9.

The outer vessel 1 and the inner vessel 5 are assembled to define a predetermined space, i.e. the heat-retaining space 9, between a bottom 3 of the outer vessel and a bottom 7 of the inner vessel 5.

Further, to mount the bimetal sensor 20 on the protrusion 11 of the outer vessel 1, a bimetal through-hole 22 is formed in the bimetal sensor 20 and a thread hole 15 is formed in the protrusion 11, so that the bimetal sensor 20 may be mounted thereon by a bimetal fastening bolt 26.

The embossed portion 24 of the bimetal sensor 20 is inserted into the air exhaust hole 13, and the bimetal fastening bolt 26 is fastened to the thread hole 15 via the bimetal through-hole 22, so that the bimetal sensor 20 is mounted on the mounting portion 12.

Then, the inner vessel 5 is fixed by a fastening bolt 51 for compressing and securing the inner vessel 5 through the threaded portion 48 of the safe connection member 40 and the connection hole 19 of the outer vessel 1.

The threaded portion 48 of the safe connection member 40 is internally threaded, and the fastening bolt 51 fastened to the threaded portion 48 is externally threaded.

Thus, if the fastening bolt 51 is partially fastened to the threaded portion 48 and then inserted into a through-hole 81 for a fastening bolt, the packing member 80 contacts and compresses the outer surface of the fastening bolt 51, thereby preventing water inflow between the outer vessel 1 and the inner vessel 5.

Further, one end of the fastening bolt 51 compresses the inner vessel 5, so that the inner vessel 5 is secured to the inside of the outer vessel 1.

The grip 32 is coupled to the safe connection member 40 by a coupling bolt 34, so that the handle 30 can be fastened to the outer surface of the outer vessel 1.

It will be appreciated that the handle 30 may be installed only at one side of the outer vessel 1 or at opposite sides of the outer vessel 1 as needed.

Next, cookware including a handle according to a second exemplary embodiment of the invention will be described with reference to the accompanying drawings.

For convenience of description, like reference numerals will be given to elements having the same configurations and functions as those of the exemplary embodiment described above, and detailed descriptions thereof will be omitted, as needed. On the other hand, the same terms but different numerals will be given to elements having the same functions but different configurations.

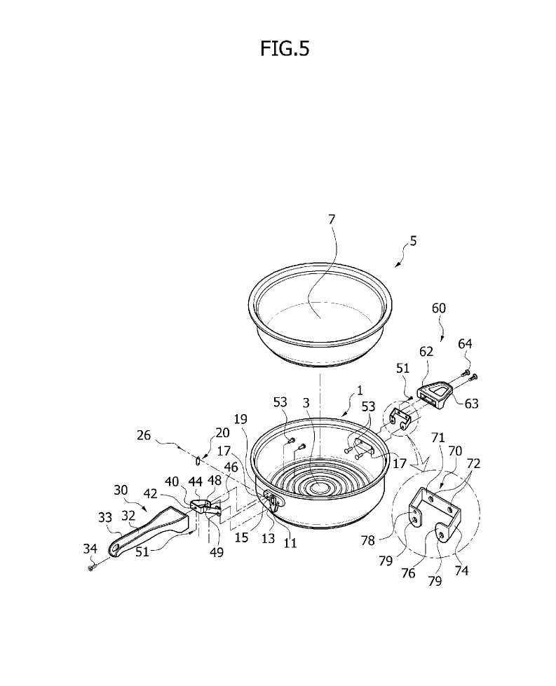

FIG. 5 is an exploded perspective view of double cookware including a handle according to a second exemplary embodiment of the present invention.

Referring to FIG. 5, in the double cookware according to this exemplary embodiment, a heat-retaining space 9 is defined between an outer vessel 1 and an inner vessel 5, and a handle 30 having a long grip 32 and a handle 60 having a short grip 62 are provided to an outer surface of the outer vessel 1.

Specifically, the handle 60 having the short grip 62 and a safe connection member 70 for mounting the handle 60 are mounted on one side of the outer vessel 1, and the handle 30 having the long grip 32 and a safe connection member 40 for mounting the handle 30 are mounted on the other side of the outer vessel 1.

The handle 60 provided with the short grip 62 may have various shapes. The grip 62 includes a second glossy boundary line 63 at a rim thereof, and the other parts of the grip 32 except for the second boundary line 63 may be subjected to mat-finish.

However, the present invention is not limited to this embodiment, and the number and positions of handles 30, 60 may be varied. For example, the double cookware may be provided with one or two handles 30 each having the long grip 32, or one or two handles 60 each having the short grip 62.

The handle 30 having the long grip 32 is described in the foregoing exemplary embodiment.

In the double cookware including the short grip 62 according to this embodiment, the handle 60 includes the grip 62, and the safe connection member 70 includes a support section 71, an inclined section 74, and securing sections 76.

Further, the support section 71, the inclined section 74 and the securing sections 76 of the safe connection member 70 may be formed by bending a metal piece positioned in the vertical direction (see FIG. 5).

If the inclined section 74 is laid in the horizontal direction (see FIG. 5), the inclined section 74 is likely to be bent when the grip 62 is subjected to force in the vertical direction.

However, when the inclined section 74 is positioned in the vertical direction as shown in FIG. 5, a vertical size of the inclined section 44 is thicker than that of the inclined sections in the case where the inclined section 74 is positioned in the horizontal direction, thereby allowing the inclined section 74 to sustain force transferred thereto in the vertical direction. As a result, the inclined section 74 is not easily deformed even by force applied to the grip 62 in the vertical direction when a user grips the handle.

With this structure of reinforcing the inclined sections 74 by positioning the inclined section 74 in the vertical direction, it is possible to prevent the inclined section 74 from being bent while using a small amount of material for the inclined section 74

The support section 71 and the inclined section 74 of the safe connection member 70 are formed to have a square-cornered ‘C’ shape, and an angle between the support section 71 and the inclined section 74 can be adjusted as needed.

Further, the inclined section 74 may slope to be higher in a direction of the grip 62 and lower at portions where the inclined section 74 contacts the outer vessel 1. Alternatively, the inclined section 74 may slope opposite to this configuration, or may be installed parallel according to various embodiments.

The securing sections 76 provided at both sides of the inclined section 74 may be bent inwards from the inclined section 74, or may be bent outwards from the inclined section 74 as needed.

The safe connection member 70 is formed with a screw hole 72, and the grip 62 is formed with a hole through which a coupling bolt 64 is fastened to the screw hole 72 of the safe connection member 70, so that the safe connection member 70 can be secured to the grip 62

The screw hole 42 of the safe connection member 40 at one side and the screw hole 72 of the safe connection member 70 at the other side are internally threaded.

The securing section 76 is formed with a threaded portion 78, and the outer vessel 1 is formed with a connection hole 19, so that a fastening bolt 51 may be fastened to the threaded portion 78 and then compress an outer surface of the inner vessel 5 through the connection hole 19, thereby securing the inner vessel 5 to the outer vessel 1.

The connection holes 19, protrusions 11, rivet holes 18 and the like are formed at opposite sides of the outer vessel 1.

The threaded portion 78 is internally threaded and coupled to a male thread formed on the outer surface of the fastening bolt 51.

Further, the securing section 76 is formed with a joint hole 79 through which a rivet 53 passes, and the outer vessel 1 is formed with a rivet hole 17 communicating with the joint hole 79, so that the rivet 53 passes through the rivet hole 17 of the outer vessel 1 and the joint hole 79 of the securing section 76 in sequence, and be fastened thereto by forcible fixing. As a result, the handle 60 is secured to the outer surface of the outer vessel 1.

The joint holes 79 are respectively formed in the left and right securing sections 76, and the threaded portion 78 is formed in one of the securing sections 76, without being limited thereto. It should be understood that the number and positions of the joint holes 79 and the threaded portion 78 may be varied

The inner vessel 5 of this exemplary embodiment may be secured to the outer vessel by being compressed at opposite sides thereof through the fastening bolt 51, or may be secured thereto by being compressed at one side thereof through the fastening bolt 51 as needed.

A method of manufacturing the double cookware according to this exemplary embodiment includes preparing the outer vessel 1 and the inner vessel 5 and forming the protrusion 11 in the outer vessel 1.

Further, a packing member 80 is inserted into the connection hole 19 defined in the protrusion 11 to prevent water inflow.

Further, with the safe connection members 40, 70 put on the outer surface of the packing member 80, a rivet 53 is inserted into the rivet hole 17 of the outer vessel 1 and the joint holes 49, 79 of the safe connection members 40, 70 to be firmly fixed thereto.

Then, the inner vessel 5 is inserted into the outer vessel 1 to form a heat-retaining space 9.

Further, to mount the bimetal sensor 20 on the protrusion 11 of the outer vessel 1, a bimetal through-hole 22 is formed in the bimetal sensor 20 and a thread hole 15 is formed in the protrusion 11, so that the bimetal sensor 20 may be mounted thereon by a bimetal fastening bolt 26.

Further, the fastening bolt 51 compresses and secures the inner vessel 5 via the threaded portion 48 of the safe connection member 40 and the connection hole 19 of the outer vessel 1, and another the fastening bolt 51 compresses and secures the inner vessel 5 via the threaded portion 78 of the safe connection member 70 and the connection hole 19 of the outer vessel 1.

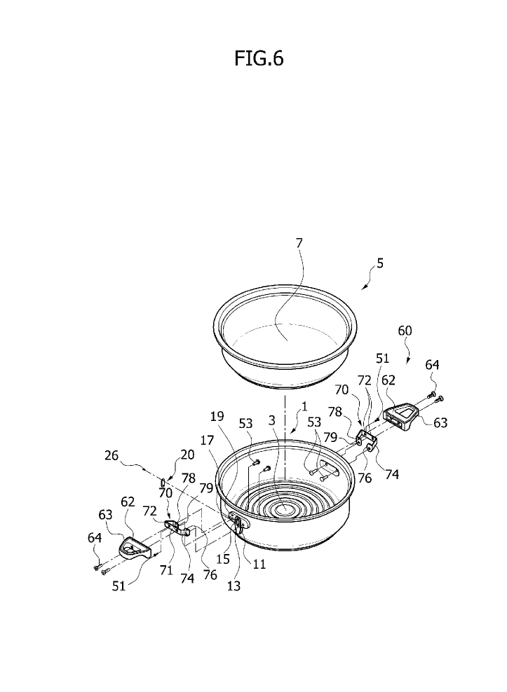

Referring to FIG. 6, in double cookware according to a third exemplary embodiment, an outer vessel 1 is provided at opposite sides thereof with handles 60 having short grips 62 and safe connection members 70 for mounting the handles 60.

Further, the double cookware in this exemplary embodiment includes a connection hole to which a resilient packing member 80 for an airtight hole is provided.

Next, double cookware according to a fourth exemplary embodiment will be described with reference to the accompanying drawings.

For convenience of description, like reference numerals will be given to elements having the same configurations and functions as those of the exemplary embodiment described above, and detailed descriptions thereof will be omitted, as needed. On the other hand, the same terms but different numerals will be given to elements having the same functions but different configurations.

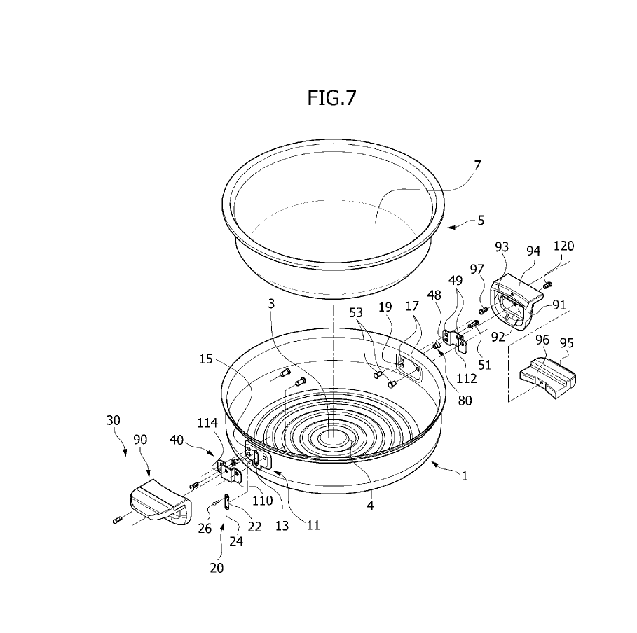

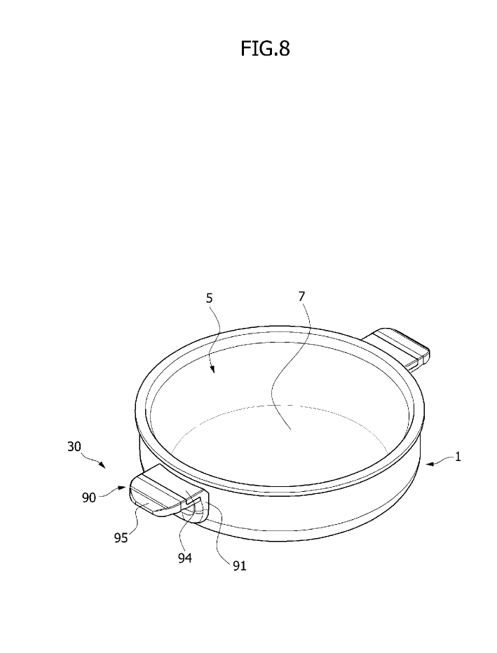

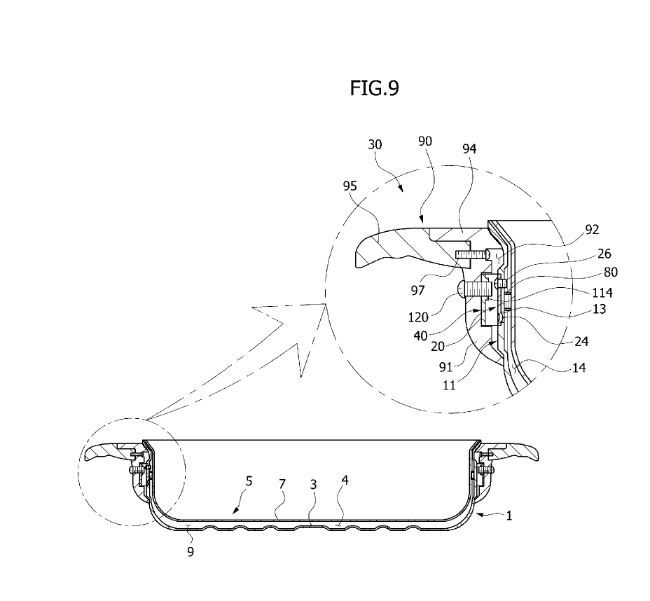

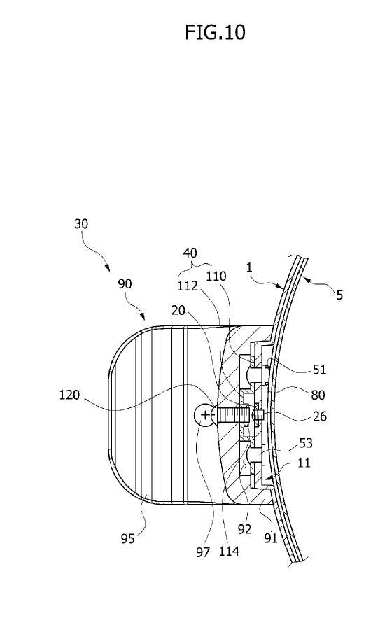

FIG. 7 is an exploded perspective view of double cookware including a handle according to a fourth exemplary embodiment, FIG. 8 is a perspective view of the double cookware including the handle according to the fourth exemplary embodiment, FIG. 9 is a side view of the double cookware according to the fourth exemplary embodiment, and FIG. 10 is a cross-section of the handle according to the fourth exemplary embodiment.

Referring to FIGS. 7 to 10, the cookware according to the fourth exemplary embodiment includes a plurality of circular grooves having different diameters on a bottom 3 of an outer vessel 1 to form an uneven bottom 4.

The uneven bottom 4 and the heat-retaining space 9 minimize the outward emission of heat transferred to the outer vessel 1, thereby enhancing cooking speed.

Further, the heat passes through the heat-retaining space 9 instead of being directly transferred to food. Thus, food is prevented from being scorched and stuck to a bottom of an inner vessel 5 and burned, and is kept warm for long time after cooking is completed.

In order to insert the inner vessel 5 into the outer vessel 1 while forming a space between the bottom 7 of the inner vessel 5 and the bottom 3 of the outer vessel 1, it is necessary to secure the inner vessel 5.

To secure the inner vessel 5, a threaded portion 48 is formed in a safe connection member 40, and a connection hole 19 is formed in a protrusion 11.

A fastening bolt 51 compresses and secures the inner vessel 5 via the threaded portion 48 of the safe connection member 40 and the connection hole 19 of the protrusion 11.

Rivet holes 17 are formed at opposite sides of the protrusion 11, and the connection hole 19 is formed near each of the rivet holes 17.

An air exhaust hole 13 is formed at the center of the protrusion 11 to communicate with a lateral channel 14, and a thread hole 15 is formed in a direction opposite to the air exhaust hole 13 to secure a bimetal sensor 20.

The safe connection member 40 secured to the outer surface of the protrusion 11 includes a securing section 110, which is formed with joint holes 49 communicating with the rivet holes 17 formed at the opposite sides of the protrusion 11 and contacts the protrusion 11, and a connecting section 112 bent from the securing section 110 towards the grip 30 and having a screw hole 114.

The securing section 110 is formed with the threaded portion 48 to which the fastening bolt 51 is fastened. Here, the safe connection member 40 is secured to the protrusion 11 such that the threaded portion 48 of the safer connection member 40 faces the connection hole 19 of the protrusion 11.

The safe connection member 40 may be made of various materials including metal, and may have various shapes so long as the safe connection member can secure the handle 30 to the protrusion 11.

To prevent water from flowing into the connection hole 19 of the protrusion 11, a packing member 80 is provided between the safe connection member 40 and the protrusion 11.

The packing member 80 is made of a resilient material such as a rubber material and is formed to have a ‘T’-shape. The packing member 80 is internally formed with a through-hole 81 for a fastening bolt.

The connection hole 19 for the packing member 80 is provided with a stepwise groove so that an upper side of the packing member 80 can be caught and fixed thereto.

The through-hole 81 in the packing member 80 has a smaller diameter than that of a fastening bolt 51, so that the fastening bolt 51 can be forcibly fitted into the packing member 80.

The packing member 80 is used to prevent water inflow between the outer vessel 1 and the inner vessel 5 along the outer surface of the fastening bolt 51.

The handle 30 secured to the outer vessel 1 via the safe connection member 40 has an inner space 92 surrounding the safe connection member 40 and the protrusion 11.

The handle 30 may have various shapes so long as it can be fastened to the safe connection member 40 with a handle securing bolt 120.

The handle 30 includes a first handle 90 which extends in a lateral direction of the outer vessel 1 and includes a first grip member 95 gripped by a user.

The first handle 90 has a small gripping area for maintenance convenience. The first handle 90 is generally used as a handle for a port.

The first handle 90 includes a first handle body 91, which has the inner space 92 surrounding the safe connection member 40 and the protrusion 11 and is installed to contact the outer vessel 1, and a first extension member 94, which extends from the first handle body 91 in a lateral direction (left and right directions in FIG. 9).

The first grip member 95 is fastened to the first extension member 94 to thereby form the first handle 90.

The first handle body 91 is provided with a first body connection hole 93 which communicates with the screw hole 114 of the safe connection member 40, and the handle securing bolt 120 is fastened to the screw hole 114 via the first body connection hole 93, so that the first handle body 91 is secured to the safe connection member 40.

The first grip member 95 and the first extension member 94 protrude in a direction of crossing each other, and are fixed by a first handle securing bolt 97, with a lower side of the first extension member 94 adjoining an upper side of the first grip member 95.

Only one first handle securing bolt 97 may be used. To enhance coupling force, two or more first handle securing bolts 97 may be used.

Referring to FIG. 7, the first grip member 95 is bent downward to form a step, and the first extension member 94 is bent upward to form a step, so that the upper side of the first grip member 95 and the lower side of the first extension member 94 contact each other.

A handle connection hole 96 is formed in the first grip member 95, and the first handle securing bolt 97 is fastened to the handle connection hole 96 of the first grip member 95 through the first handle body 91, so that the first grip member 95 is secured to the first extension member 94.

The first handle securing bolt 97 may be fastened to the handle connection hole 96 formed in a side surface of the first grip member 95 through a side surface of the first handle body 91. Alternatively, the first handle securing bolt 97 may be fastened to the first extension member 94 through the first grip member 95 in a state that the first extension member 94 connected to the first handle body 91 is laid on the first grip member 95. As such, the first handling securing bolt 97 may be fastened in various forms.

Further, the first grip member 95 and the first extension member 94 are separately provided and then assembled. Alternatively, the first grip member 95 may be integrally formed with the first extension member 94.

Next, a method of manufacturing double cookware according to the fourth exemplary embodiment will be described with reference to accompanying drawings.

Referring to FIGS. 7 to 10, the cookware according to this embodiment includes the outer vessel 1 and the inner vessel 5, and is formed with the protrusion 11 on the outer vessel 1.

The protrusion 11 is formed by pressing or injection-molding the outer vessel 1 to protrude outward from a lateral side of the outer vessel 1.

Further, a packing member 80 is inserted into a connection hole 19 defined in the protrusion 11 to prevent water inflow.

With the packing member 80 inserted into the connection hole 19, the securing section 110 of the safe connection member 40 is secured to the protrusion 11.

Since the fastening bolt 51 is fastened to the threaded portion 48 of the safe connection member 40 via the packing member 80 and the connection hole 19, and one end of the fastening bolt 51 compresses the outer surface of the inner vessel 5 inserted into the outer vessel 1, the inner vessel 5 is secured to the inside of the outer vessel 1.

The outer vessel 1 and the inner vessel 5 are assembled to define a predetermined space, i.e. a heat-retaining space 9, between a bottom 3 of the outer vessel 1 and a bottom 7 of the inner vessel 5.

With the rivet 53 inserted into the rivet hole 17 of the protrusion 11 through the joint hole 49 of the safe connection member 40, the rivet 53 inserted into the outer vessel 1 is compressed, so that the safe connection member 40 can be firmly secured to the protrusion 11.

With the safe connection member 40 and the protrusion 11 inserted into the inner space 92 of the first handle body 91, the handle securing bolt 120 is fastened to the screw hole 114 of the safe connection member 40 through the first body connection hole 93 of the first handle body 91, so that the first handle body 91 can be secured to the safe connection member 40.

Since the first handle body 91 is secured to the outer vessel 1, the protrusion 11 and the safe connection member 40 are shielded from the outside, thereby preventing inflow of foreign matter.

With the first extension member 94 adjoining the first grip member 95 to face each other, the first handle securing bolt 97 is fastened to the handle connection hole 96, which extends to the first grip member 95 through the first handle body 91, so that the first grip member 95 may be secured to the first extension member 94.

To mount the bimetal sensor 20 on the protrusion 11 of the outer vessel 1, a bimetal fastening bolt 26 is fastened to a thread hole 15 through a bimetal through-hole 22, and an embossed portion 24 is placed in the air exhaust hole 13.

It will be appreciated that the handle 30 may be installed only at one side of the outer vessel 1 or at opposite sides of the outer vessel 1 as needed

With the foregoing configurations, since the structures placed in a part where the outer vessel 1 and the handle 30 are in contact with each other are covered to satisfy aesthetic sense while preventing inflow of foreign matter to facilitate cleaning operation, the double cookware according to the fourth exemplary embodiment exhibits improved user convenience.

Next, double cookware according to a fifth exemplary embodiment of the invention will be described with reference to accompanying drawings.

For convenience of description, like reference numerals will be given to elements having the same configurations and functions as those of the exemplary embodiment described above, and detailed descriptions thereof will be omitted, as needed. On the other hand, the same terms but different numerals will be given to elements having the same functions but different configurations.

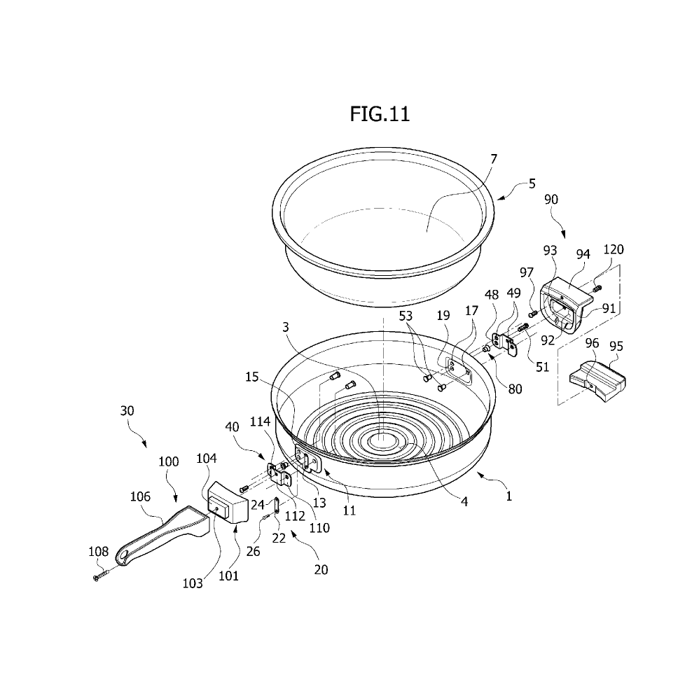

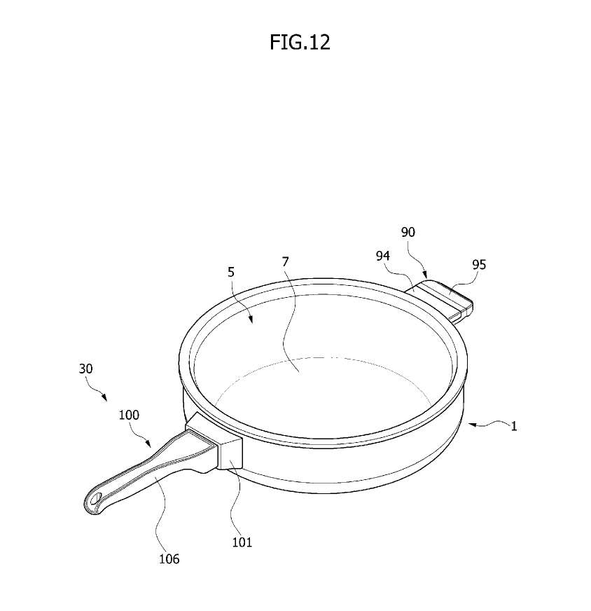

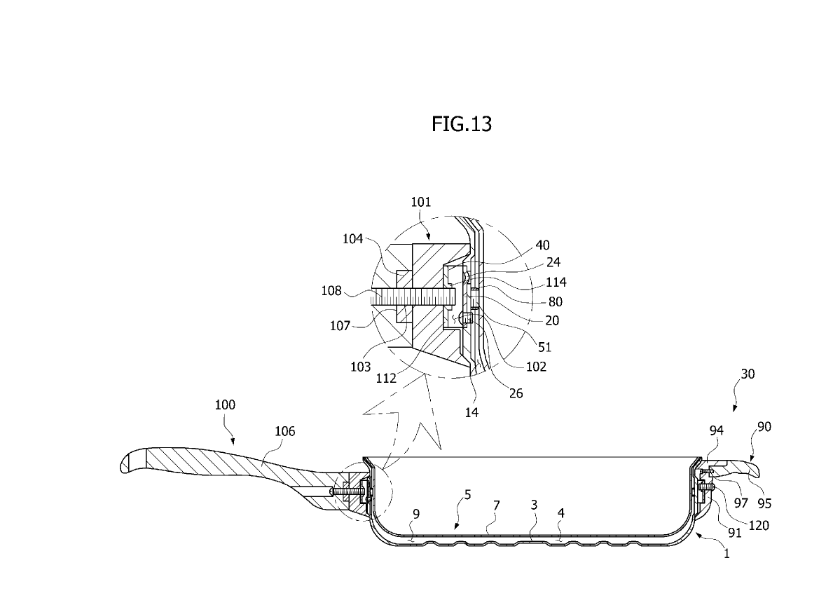

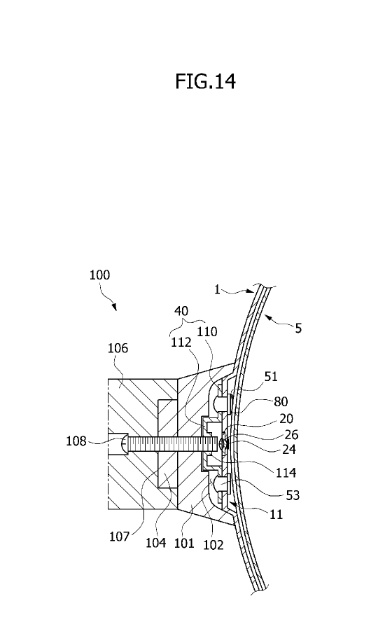

FIG. 11 is an exploded perspective view of double cookware including a handle according to a fifth exemplary embodiment, FIG. 12 is a perspective view of the double cookware including the handle according to the fifth exemplary embodiment, FIG. 13 is a side view of the double cookware according to the fifth exemplary embodiment, and FIG. 14 is a cross-section of the handle according to the fifth exemplary embodiment.

Referring to FIGS. 11 to 14, the double cookware according to the fifth exemplary embodiment includes a handle 30 installed to contact an outer vessel 1. The handle 30 includes a second handle 100, which extends in a lateral direction of the outer vessel 1 (left and right directions in FIG. 13) and is provided with a second grip member 106 to be gripped by a user.

The second handle 100 has a larger gripping area than the first handle 90 and is applicable to containers such as frying pans.

The second handle 100 includes a second handle body 101, which has an inner space 102 surrounding a safe connection member 40 and a protrusion 11 and is installed to contact the outer vessel 1.

A second extension member 104 protrudes from the second handle body 101 in the lateral direction, and a coupling groove 107 is provided inside the second grip member 106 opposite the second extension member 104.

The second extension member 104 is fastened by a second handle securing bolt 108 while being inserted into the coupling groove 107.

The safe connection member 40 is divided into a connecting section 112 and a securing section 110. The connecting section 112 is formed with a screw hole 114 communicating with a second body connection hole 103 of the second extension member 104.

The second handle securing bolt 103 is fastened to the screw hole 114 having a female thread through the second grip member 106 and the second body connection hole 103, so that the second grip member 106, the second handle body 101 and the safe connection member 40 are integrally secured.

Since the second handle body 101 is secured to the outer vessel 1 while surrounding the safe connection member 40 and the protrusion 11, the second handle body 101 prevents foreign matter from being introduced into the safe connection member 40 or the protrusion 11 and provides pleasant appearance to the cookware.

Although the present invention has been described with reference to the embodiments and the accompanying drawings, the present invention is not limited to these embodiments and the drawings. It should be understood that various modifications, additions and substitutions can be made by a person having ordinary knowledge in the art without departing from the scope and spirit of the invention as disclosed in the accompanying claims.

Further, although the handle is illustrated as being provided to the double cookware, it should be understood that this configuration is provided for illustration only. Besides the double cookware, the handle according to the exemplary embodiments of the present invention may be applied to frying pans or various cooking utensils.

Therefore, the spirit and scope of the present invention are defined only by the accompanying claims and equivalents thereof.

What is claimed is:

1. Double cookware comprising: an inner vessel, an outer vessel, a protrusion formed on a lateral side of the outer vessel, a rivet hole formed in the protrusion, a safe connection member connected to a handle to be coupled to the rivet hole and having a joint hole formed therein, a rivet inserted into the joint hole via the rivet hole and forcibly secured thereto, a space defined between a bottom of the inner vessel and a bottom of the outer vessel when inserting the inner vessel into the outer vessel, a bimetal through-hole formed in a bimetal sensor in order to mount the bimetal sensor, which is automatically opened/closed depending on temperature, to the protrusion, a thread hole formed in the protrusion to be fastened by a bimetal fastening bolt, and a fastening bolt compressing and securing the inner vessel with respect to the outer vessel through a threaded portion of the safe fastening unit and a connection hole of the outer vessel.

2. The double cookware according to claim 1, wherein the safe connection member comprises a horizontal support section, an inclined section inclined downward at either side of the support section, and securing sections bent from both sides of the inclined section to contact and be secured to the outer vessel, the support section, the inclined section and the securing section being formed by bending a metal piece positioned vertically.

3. The double cookware according to claim 1, wherein the bottom of the outer vessel and the bottom of the inner vessel define a heat-retaining space therebetween, a lateral channel forms an air passage between the outer vessel and the inner vessel to communicate with the heat-retaining space, and an embossed portion of the bimetal sensor mounted on a mounting portion communicating with the lateral channel is inserted into an air exhaust hole formed in the mounting portion, the embossed portion of the bimetal sensor being automatically opened and closed in accordance with a temperature of the heat-retaining space and the lateral channel

4. The double cookware according to claim 1, wherein a packing member for preventing water from flowing through a through-hole for securing the inner vessel is inserted into the connection hole of the outer vessel.

5. The double cookware according to claim 1, wherein the outer vessel is provided at opposite sides thereof with handles having short grips and safe connection members for mounting the handles, respectively.

6. The double cookware according to claim 1, wherein the outer vessel is provided at one side thereof with a handle having a short grip and a safe connection member for mounting the handle, and at the other side thereof with a handle having a long grip and a safe connection member for mounting the handle.

7. The double cookware according to claim 1, wherein the handle has a space which surrounds the safe connection member and the protrusion.

8. The double cookware according to claim 7, wherein the handle comprises a first handle extending in a lateral direction of the outer vessel and including a first grip member to be gripped by a user.

9. The double cookware according to claim 8, wherein the first handle comprises a first handle body installed to contact the outer vessel and having an inner space surrounding the safe connection member and the protrusion, and a first extension member extending in the lateral direction from the first handle body, the first grip member being fastened to the first extension member.

10. The double cookware according to claim 9, wherein the first grip member and the first extension member protrude in a direction of crossing each other and are fastened to each other by a first handle securing bolt with a lower side of the first extension member contacting an upper side of the first grip member.

11. The double cookware according to claim 7, wherein the handle comprises a second handle extending in a lateral direction of the outer vessel and including a second grip member to be gripped by a user.

12. The double cookware according to claim 11, wherein the second handle comprises a second handle body installed to contact the outer vessel and having an inner space surrounding the safe connection member and the protrusion, and a second extension member extending in the lateral direction from the second handle body, and a coupling groove is provided inside the second grip member opposite the second extension member, the second extension member being inserted into the coupling groove and being fastened thereto by a second handle securing bolt.

13. The double cookware according to claim 1, wherein the safe connection member comprises a securing piece having the joint hole communicating with a rivet holes formed at either side of the protrusion and installed to contact the protrusion; and a connecting piece bent from the securing piece towards the handle and having a screw hole formed therein.

14. A method of manufacturing double cookware, comprising:
preparing an outer vessel and an inner vessel and forming a protrusion on the outer vessel;
inserting a packing member for preventing water inflow into a connection hole formed in the protrusion;
compressing and securing a rivet having passed through a rivet hole of the outer vessel and a joint hole of a safe connection member, with the safe connection member placed on an outer surface of the packing member;
forming a heat-retaining space by inserting the inner vessel into the outer vessel;
mounting a bimetal sensor on the protrusion of the outer vessel by forming a bimetal through-hole in the bimetal sensor and a thread hole in the protrusion and fastening the bimetal fastening bolt thereto; and
securing the inner vessel with a fastening bolt compressing and securing the inner vessel through a threaded portion of the safe connection member and a connection hole of the outer vessel.

15. A method of manufacturing double cookware, the method comprising:
preparing an outer vessel and an inner vessel and forming protrusions at opposite sides of the outer vessel;
inserting a packing member for preventing water inflow into a connection hole provided in the protrusion;
compressing and securing a rivet having passed through a rivet hole of the outer vessel and joint holes of safe connection members, with the safe connection members placed on an outer surface of the packing member;
forming a heat-retaining space by inserting the inner vessel into the outer vessel;
mounting a bimetal sensor on the protrusion of the outer vessel by forming a bimetal through-hole in the bimetal sensor and a thread hole in the protrusion and fastening the bimetal fastening bolt thereto; and
securing the inner vessel with a fastening bolt compressing and securing the inner vessel through a threaded portion of the safe connection member and a connection hole of the outer vessel, and with another fastening bolt compressing and securing the inner vessel through a threaded portion of the safe connection member and the connection hole of the outer vessel.
